(19) United States
(12) Patent Application Publication
(10) Pub. No.: US 2026/0046218 A1
(43) Pub. Date: Feb. 12, 2026

(54) METHOD OF ARTIFICIAL INTELLIGENCE-ASSISTED CONFIGURATION IN WIRELESS COMMUNICATION SYSTEM

(71) Applicant: ZTE Corporation, Shenzhen (CN)

(72) Inventors: Fei DONG, Shenzhen (CN); He HUANG, Shenzhen (CN); Jing LIU, Shenzhen (CN); Jiajun CHEN, Shenzhen (CN)

(73) Assignee: ZTE Corporation, Shenzhen, GD (CN)

(21) Appl. No.: 19/046,310

(22) Filed: Feb. 5, 2025

Related U.S. Application Data
(63) Continuation of application No. PCT/CN2022/111559, filed on Aug. 10, 2022.

(51) Int. Cl. H04L 41/16; H04B 7/06; H04W 72/21

(52) U.S. Cl. CPC H04L 41/16; H04B 7/0626; H04W 72/21

(57) ABSTRACT

This disclosure is generally directed to wireless communication systems and methods and relates particularly to a mechanism for implementing an artificial intelligence framework for adaptively configure the over-the-air communication interfaces of the wireless communication systems. AI network configuration functions may be provided as services for AI-assisted network configuration (AI configuration services, or AICS). Such AICS may be requested and configured via various messaging and signaling mechanisms. The AI model life cycle management including training, delivery, activation, inference, deactivation, switching, performance evaluation, and the like may be configured, triggered, and otherwise provisioned via control and data messages and signaling communicated between the various network elements in the wireless communication system.

### TECHNICAL FIELD

This disclosure is generally directed to wireless communication systems and methods and relates particularly to a mechanism for implementing an artificial intelligence framework for adaptively configure the over-the-air communication interfaces of the wireless communication systems.

### BACKGROUND

In a wireless communication system, determination of adaptive network configuration particularly within an over-the-air communication interface may require lengthy measurement processes and/or significant amounts of computation power. Such types of configurations may include but are not limited to beam management, channel state information (CSI) feedback compression and decompression, and wireless terminal positioning. Correlation between various network conditions and these adaptive configurations may be learned via artificial intelligence (AI) techniques and models. It may thus be desirable to provide a mechanism for provisioning a lifecycle of various AI models and their applications in assisting in adaptively determining these network configurations.

### SUMMARY

This disclosure is generally directed to wireless communication systems and methods and relates particularly to a mechanism for implementing an artificial intelligence framework for adaptively configure the over-the-air communication interfaces of the wireless communication systems. AI network configuration functions may be provided as services for AI-assisted network configuration (AI configuration services, or AICS). Such AICS may be requested and configured via various messaging and signaling mechanisms. The AI model life cycle management including training, delivery, activation, inference, deactivation, switching, performance evaluation, and the like may be configured, triggered, and otherwise provisioned via control and data messages and signaling communicated between the various network elements in the wireless communication system.

In some example implementations, a method, by at least one wireless network node, is disclosed. The method may include activating an Artificial Intelligence (AI) network configuration mode in response to receiving a request for AICS (AI configuration service) from a wireless terminal device; determining a network-side AI model according to the request for AICS; receiving a set of input data items to the network-side AI model from the wireless terminal device; determining a network configuration action (NCA) based on an inference from the network-side AI model based on the set of input data items; transmitting the NCA or an indication for the NCA to the wireless terminal device; receiving an AI feedback data item from the wireless terminal device, the AI feedback data item being generated by the wireless terminal device based on a deployment outcome of the NCA according to the indication; and preforming at least one AI network configuration management task according to the AI feedback data item.

In some other implementations, a method, by a wireless terminal device, is disclosed. The method may include transmitting a request for AI configuration service (AICS) to at least one wireless network node; receiving a management configuration for the AICS; receiving an activation indication associated with a UE-side AI model; receiving a set of assistant information items associated with the UE-side AI model; in response to the activation indication, performing an AI-inference to generate an inference data item using the UE-side AI model based on the set of assistant information items; transmitting the inference data item to the at least one wireless network node; receiving a network configuration action (NCA) determined by the at least one wireless network node based on the inference data item; and performing or assisting the at least one wireless network node in performing AI service management according to the management configuration for the AICS and the inference data item.

In some other implementations, a wireless device comprising a processor and a memory is disclosed. The processor may be configured to read computer code from the memory to implement any one of the methods above.

In yet some other implementations, a computer program product comprising a non-transitory computer-readable program medium with computer code stored thereupon is disclosed.

The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations or UEs and a wireless access network node in communication with one another via an over-the-air radio communication interface.

FIG. 3 shows example functional blocks for a general AI platform in a wireless communication network.

FIG. 4 shows a data and logic flow for provisioning and managing offline-trained AI models on a network-side of a wireless communication network.

FIG. 5 shows a data and logic flow for provisioning and managing online-trained or reinforcement-trained AI models on a network-side of a wireless communication network.

FIG. 6 shows a data and logic flow for provisioning and managing offline-trained AI models on a terminal side of a wireless communication network.

FIG. 7 shows a data and logic flow for provisioning and managing online-trained or reinforcement-trained AI models on a terminal side of a wireless communication network.

FIG. 8 shows a data and logic flow for provisioning and managing offline-trained AI models on both a network side and a terminal side of a wireless communication network.

FIG. 9 shows a data and logic flow for provisioning and managing online-trained or reinforcement-trained AI models on both a network side and a terminal side of a wireless communication network.

### DETAILED DESCRIPTION

The technology and examples of implementations and/or embodiments described in this disclosure can be used to facilitate adaptive and intelligence network configuration related to, for example, an over-the-air communication interface in a wireless communication system. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to wireless communication systems and methods and relates particularly to a mechanism for implementing an artificial intelligence framework for adaptively configure the over-the-air communication interfaces of the wireless communication systems. AI network configuration functions may be provided as services for AI-assisted network configuration (AI configuration services, or AICS). Such AICS may be requested and configured via various messaging and signaling mechanisms. The AI model life cycle management including training, delivery, activation, inference, deactivation, switching, performance evaluation, and the like may be configured, triggered, and otherwise provisioned via control and data messages and signaling communicated between the various network elements in the wireless communication system.

### Wireless Network Overview

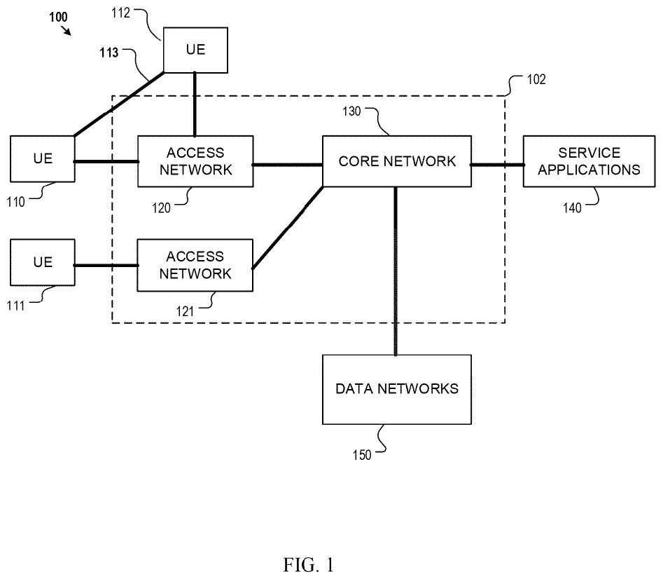

An example wireless communication network, shown as 100 in FIG. 1, may include wireless terminal devices or user equipment (UE) 110, 111, and 112, a carrier network 102, various service applications 140, and other data networks 150. The carrier network 102, for example, may include access networks 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

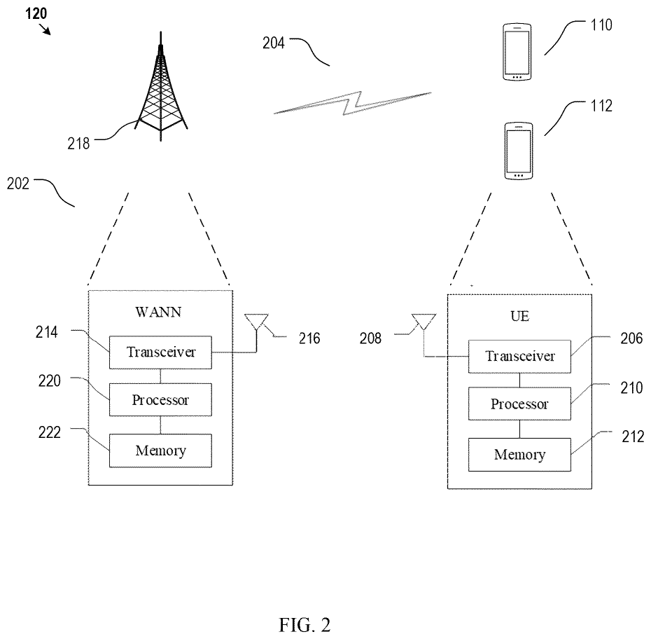

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

### AI in Wireless Network Configuration

At the core of a general AI framework are various AI models. An AI model generally contains a large number of model parameters that are determined through a training process where correlations in a set of training data are learned and embedded in the trained model parameters. The trained model parameters may thus be used to generate inference from a set of input dataset that may not have existed in the training dataset. AI models are particularly suitable for situations where there is few trackable deterministic or analytical derivation paths between input data and output.

In a wireless communication system such as the ones described above, determination of adaptive network configuration may rely on empirical characteristics and my further require lengthy measurement processes and/or significant amounts of computation power. Such types of configurations may include but are not limited to over-the-air interface beam management, channel state information (CSI) feedback compression and decompression, and wireless terminal positioning. Correlation between various network conditions and these adaptive configurations may be leaned via artificial intelligence (AI) techniques. The use of AI models for assisting in network configuration may thus help reduce the amount of measurements and computation requirement, providing a more agile network configuration. Accordingly, it may thus be desirable to provide a mechanism for provisioning a lifecycle of various AI models and the applications in assisting in the adaptively determining these network configurations.

For example, AI technology may be applied to beam management in the over-the-air communication interface. In current implementations, beam management typically relies on the exhaustive searching beam sweeping. In other words, the network (NW) may perform a full sweep of the beams by sending sufficient number of reference signals. A UE may be configured to monitor and measure each reference signal and then report the measurement result to NW for the NW to decide the best beam for the UE to switch to. This process, however, is resource and power intensive. With trained AI models that embed learned correlation between various network condition parameters, few measurements (or fewer reference signals) may be needed in order to accurately infer the best beams. In some implementations, AI model may help identify inference of best candidate beams using other network conditions and then only sweep and measure the candidate beams to select the beam for use in current communication. Additionally, as beam configuration is closed tied to a location of the UE, AI technology may further be used for inferring or predicting UE trajectory or location, thereby indirectly help selection of best beams.

For another example, AI technology may be applied to channel state information (CSI) feedback. Traditionally, the CSI feedback may be implemented using a codebook known by UE and NW. The UE may measure the CSI and obtain a measurement result, and then map the measurement result to a closest vector of the codebook, and transmit the index of that vector to the NW in order to save the air-interface resource consumption. However, because the codebook is not unlimited or dynamic changeable over time, there would be always mismatch, thereby causing un-controlled CSI feedback errors as the wireless environment varies. AI thus may be applied to compression-decompression for CSI feedback. Specifically, a CSI report may be compressed by a UE-side AI model and decompressed by a corresponding NW-side AI model. Such AI models may be initially trained and continuously developed over time and accumulation of network conditions.

For yet another example, AI technology may be applied to UE positioning. Traditional approaches for UE positioning depend on PRS or SRS (e.g. DL Positional Reference Signal and uplink Sounding Reference Signal). Regardless of the alternative approaches, the LOS (Line-Of-Sight) beams are the key beams to identify in order to generate the most precise location estimation by triangulation at the NW side. However, in most case, it is difficult to identify the LOS beams from other NLOS (Non-Line-Of-Sight) beams, thereby providing in accurate UE positioning. A trained AI model, on the other hand, may identify various pattern and correlation in the PRS and SRS for extracting LOS information and providing more accurate UE positioning.

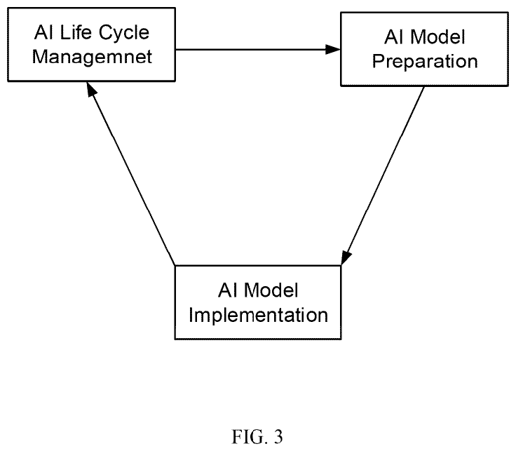

In some example implementation of the current disclosure, AI technology may be provided as a service including various configuration functions that may each be associated with one or more AI models that may be trained offline or continuously trained online. Such AI functions may be requested by a terminal device. The AI functions may be provided in an AI provisioning platform that supports several example aspects of the AI functions, as illustrated in FIG. 3 and described below:

AI model preparation, which may include at least one of the following parts:
a) Model training, including offline training, online training, and reinforcement training.
   i. Offline training: an AI model may be pre-trained or offline trained/validated/tested and stored at NW or UE side. For example, some AI models may be trained offline successfully and are not developed/reinforced during the implementation of the AI-based function. In some implementations, the term offline training at a UE or NW side is used to mean that the AI models have been trained and tested successfully before the UE enters RRC-Connected state rather than being trained or reinforcement trained during the RRC-Connected state.
   ii. Online training. There may be two example cases of online training of AI models. In one example, an AI model can be partially trained offline and then have a reinforcement training or continues training with the online datasets. In the other example, the AI model is trained with the online datasets only. In some example implementation, online training at a UE or the NW side means the AI model need to be reinforcement trained or trained after the UE enters into an RRC connected status. In some example implementation, due to its real-time nature, online training for an AI model may be managed by an AI-training timer for avoiding training processes that are excessively long to converge or non-converging at all. Such an AI-training timer, for example, may be started or restarted upon the start of the AI model training, and stopped upon the successful training, and upon expiration of the timer, the AI model training can be considered as failed if the training has not sufficiently converged.
b) AI model transfer with respect how are the trained models being delivered to the NW and/or the UE, either via wireline or radio interface.
c) One side model vs. two-side model: A determination may be made for a particular AI function where the AI model should reside for inference and/or training. The AI model may reside either on the NW side or the UE side for inference or training. For some applications, the AI models may reside on both sides for inference or training and collaboratively perform a particular network function. In some implementations, a training location and an inference location may be different for some AI models. For example. an AI model may be trained on the network side but may be deployed to the UE side for inference.
d) The other information exchange between NW and UE for AI model training/inference. Such information, as described in further example below, may include training data and other AI model assistant information. Such information may be transmitted between the NW and the UE via one or more messages and signaling of various types.
   2. AI model implementation. Using the AI models for inference may include at least one of the following aspects:
a) The input data generation, preparation, and transfer/delivery for AI model inference.
b) Transfer and processing of the output of the AI model inference.
c) The location of AI model inference, either on the NW or UE side, as described above.
   3. Life cycle management. AI life cycle management may be provided via, for example, activation and deactivation of AI functions/models as a whole or of a particular AI function/model. Such life-cycle management may be based one or more of the following schemes:
a) Time based management. For example, an AI model specific timer for an AI model may be configured as part of the AI life-cycle management configuration. Such a timer may, for example, be started when the AI model is activated and the timer maybe restarted when UE/NW send the feedback information for AI model performance evaluation or when UE/NW determine that the AI model is still workable via the performance evaluation, and the AI model specific timer may be stopped when the AI model is deactivated and/or switched to another AI model. The effect of an expired model-specific timer may set the AI model as unavailable for inference, unless reactivated. In some other implementations, the AI functions may be managed as a whole with a single timer.
b) Event based management. The activated AI model would be deactivated and considered as not available due to the occurrence of one or more events, as described in more detail below.
c) Performance evaluation-based management. Performance of the inference by the AI model may be used in the management of AI functions. For example, inference criteria may be pre-defined for evaluating the performance of an AI model. If the performance evaluation shows that a particular AI model is no longer suitable for the current physical/network environment, that AI model will be considered as not workable and may be disabled or replaced.

In some implementations, the AI functions may be provided as on or more configuration modes signaled in any suitable control message or control field in a control message. The various control messages and signaling format may be adjusted to accommodate the implementation of the AI functions.

### Example AI Functions for Configurations of the Over-the-Air Interface

AI models may be activated for determining various network configurations that may otherwise involve resource and power intensive processes to determine. While the examples below focus on AI-assisted determination of various aspects of the over-the-air-interface configuration, the underlying principles and architectures so described are applicable to other network configuration determination/selection in the wireless network communication system.

### EXAMPLE 1

### AI-Based Beam Management

Without AI assistance, traditional beam management and configuration involves the NW need sweeping all beams by various reference signals. A UE is correspondingly configured to perform measurement for all reference signals (RSs), and then report the Reference Signal Receive Power (RSRP) of all RSs to the NW. It is then up to the NW to decide the best beam and then adjust/configure DL/UL beams for UE.

AI-based beam management/configuration scheme may be implemented for spatial and/or temporal beam management/configuration. In AI-based spatial beam management, the NW may only need to sweep part of full beams, and hence the UE only need to perform measurement for the reduced number of swept beams. The RSRP of reference signals associated with all beams including the non-swept beams may be deducted from the RSRP of these partial beams using a trained AI model for beam inference. Such a model may be developed for recognizing correlations RSRP of various beams in various network conditions (which can also be part of the input to the AI model for beam inference). The best beam can be selected based on the inference from the AI model.

In an AI-based temporal beam management application, the AI model may be trained and used to deduce the beams pattern for the next time period according to the beams pattern of the current time period. Such an AI model is trained to recognize correlation between bean patterns between time instances.

### EXAMPLE 2

### AI-Based CSI Feedback Enhancement

In an example implementation, a two-side AI approach may be applied. In other words, AI models are used in both the UE side and the NW side for generating inference. Specifically, the UE-side AI model may be used for compressing CSI feedback to generated compressed CSI feedback whereas the NW side AI model may be used for decompressing the compressed CSI feedback to generate decompressed CSI feedback. Such AI model may be inherently nonlinear and thus support non-linear compression and decompression that are difficult to implement and thus lacking in traditional type II codebook-based CSI feedback scheme. Such non-linear process offers higher accuracy in CSI feedback and significant resource saving.

As described in the various example implementations below, AI network configuration functions may be provided as services for AI-assisted network configuration (AI configuration services, or AICS). Such AICS may be requested and configured via various messaging and signaling mechanisms. The AI model life cycle management including training, delivery, activation, inference, deactivation, switching, performance evaluation, and the like may be configured, triggered, and otherwise provisioned via control and data messages and signaling communicated between the various network element in the wireless communication system.

The various example implementations are categorized by AICS with respect to options related to a location of the AI models (either on the NW side or the UE side, or both), the training process of the AI models (pretrain/offline training, or online training or reinforcement training). These different options may be implemented as different AICS modes, in parallel or other relation with non-AI mode. These modes may be separately managed with respect to different type of network configuration functions, such as beam configuration and CSI feedback function.

### Case 1: NW Side Model, Offline Training

In this case, the AI model may be trained at NW side offline. These AI models may be developed by NW vendors, or developed by other vendors but upload to NW vendors before the implementation of the AI model, and the training process and model selection for AI-based function may be transparent to any network specification. For the model evaluation, it may also be up to the NW vendors or the model developers to decide whether the model is sufficient accurate or workable, and that also can be transparent to the specification.

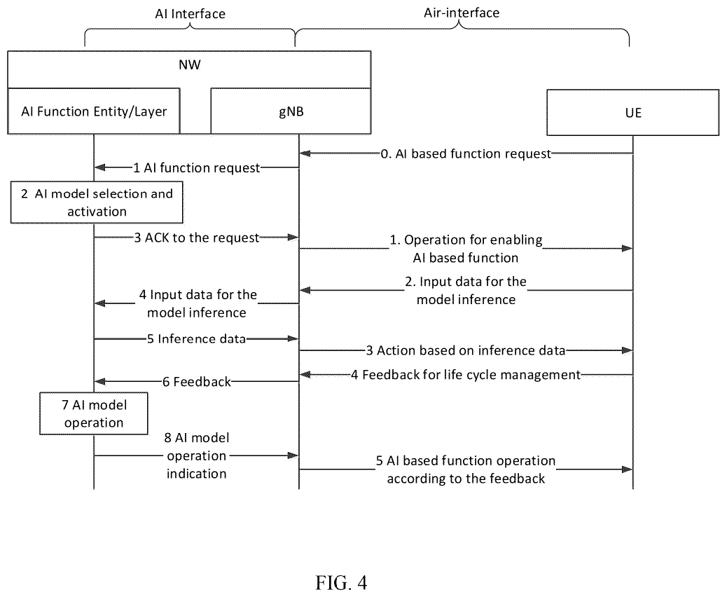

An example general procedure in terms of data and logic flow of information for requesting and providing AICS using offline-trained AI models is shown in FIG. 4.

In some implementations, the NW side may be further configured with a separate function, entity, layer, or OAM (Operation, Administration, and Management functions) that handle the AICS provisioning and configuration. Such entity may reside in the core network shown in FIG. 1. Alternatively, it may be part of the access network. In some implementations, such an entity may reside in the base station, such as a gNB as a separate function. In some other implementations, the AI entity and the gNB functions may be integral part of the base station. In such implementations, the information exchange via AI-interface described below will not be relevant and the operation of AI function entity/layer would be considered as part of gNB's operation. When the AI entity and the gNB are separately implemented (either functionally or physically), the communication interface therebetween (both data and control) may be referred to as AI interface, whereas the communication between the UE or wireless terminal device and the gNB or other base stations may be referred to as the air-interface, as shown in FIG. 4.

As further shown in FIG. 4, the example general procedure in the air-interface for case 1 may include:
Step 0: the UE may send an indication of requesting the AI-based function or service (or AICS) to the NW. Alternatively, the NW determines that the AI-based function can be enabled.
Step 1: Some operations are implemented by the NW for enabling the AI-based function if there is at least one AI model associated with or suitable for the requested AI-based function can be found, otherwise, the procedure ends.
Step 2: the UE sends the input data for generating model inference to the NW
Step 3: the NW performs the model inference according to the received input data (by processing the input data, either as is, or with additional processing through the AI model), and then take an action for AI-based function according to output of the model inference.
Step 4: the UE sends a feedback for performing AI model life management or model operation to the NW. The NW implement the model operation according to the feedback information.
Step 5: the NW implements the model operation for AI-based function.

The example general procedure via AI-interface in FIG. 4 may include:
Step 1: the gNB sends the request of the AI-based function to the AI entity/layer.
Step 2: the AI entity/layer selects an AI model for the requested AI-based function.
Step 3: if there is at least one AI model can be selected and suitable for the requested AI-based function, the AI entity/layer sends an ACK to request to the gNB, otherwise, the procedure ends.
Step 3: the gNB starts sending the input data to the AI function layer/entity and obtain the output data from AI function layer/entity for AI-based function.
Step 4: the gNB sends the input data for model inference to the AI entity/layer.
Step 5: AI entity/layer sends the output of the model inference to the gNB.
Step 6: the gNB sends the feedback for AI model life cycle management to AI entity/layer.
Step 7: AI entity/layer implements the model operation according to the feedback.
Step 8: AI entity/layer informs the gNB of the model operation for further the gNB operation to the AI-based function within air-interface.

Below provides further detailed description of the steps above implemented in the air-interface.

### For Step 0 in Air-Interface

The request of the AI-based function, such as beam management may embedded/encapsulated in or carried by at least one of the following messages/signaling/formations:
1. uplink (UL) media access layer (MAC) control element (CE); UL MAC CE;
2. Uplink Control Information (UCI);
3. Scheduling request (SR)/physical uplink control channel (PUCCH) signaling with a format;
4. UE Assistance information (UAI), e.g., one form of uplink radio research control (RRC) signaling; or
5. UE capability signaling.

In any one of above alternative options for the request for AICS, at least one of the following information may be included in the request:
1. AI-based function information: to indicate the requested AI-based function from a list of functions (e.g. AI-based spatial beam management, AI-based temporal beam management, AI-based positioning, AI-based CSI feedback, etc.). Such AI-based functions may be represented by predefined indices or may be represented by predefined AI function IDs. In the implementation of the AI-based beam management, UE may include the AI based function ID corresponding to the AI-based beam management in the request message.
2. Assistance information for AI model selection/training: to indicate what types of information that can be provided by UE for model selection or model training. For example, for AI-based beam management such model selection or training information may include a UE location information, speed information, direction information, or orientation information, and the like of the UE or wireless terminal device.

### For Step 1 in the Air-Interface

In response to the AI-based function request from the UE, the NW (e.g., the base station) may then perform a set of operations for enabling the requested AI functions. For example, without limitation, a set of operations may be performed for enabling AI-based beam management as an example request. For a requested AI-based beam management, such NW operation may include one or more of the operations including but not limited to the following:
1. Change the CSI measurement configuration for non-AI-based beam management to another CSI measurement configuration for AI-based beam management. For example:
   a) Active a semi-periodic CSI report which is associated with a specific set of CSI resource set for AI-based beam management via a DL MAC CE;
   b) Deactivate the semi-periodic CSI report which is associated with a CSI resource set for non-AI-based beam management via a DL MAC CE;
   c) Enable/add a periodic CSI report configuration which is associated with a specific set of CSI resources for AI-based beam management via RRC reconfiguration;
   d) Disable/Remove a periodic CSI report configuration which is associated with a set of CSI resources for non-AI-based beam management via RRC reconfiguration;
   e) For one specific CSI measurement configuration (e.g. including CSI resource set and corresponding CSI report), Change from the CSI resource set for non-AI-based beam management to a CSI resource set for AI-based beam management, which can be implemented by at least one of the following nonlimiting set of operations:
      i. For one specific CSI report configuration for non-AI-based beam management, the CSI resource (set) associated with a CSI report configuration can be dynamically changed by using a DL MAC CE.
      ii. For one specific CSI report configuration for non-AI-based beam management, the CSI report period value can be dynamically changed by a DL MAC CE.
      iii. For one specific CSI resource set configuration for non-AI-based beam management, the CSI resource period can be dynamically changed by a DL MAC CE.
      iv. For one specific CSI resource set configuration for AI-based beam management, the CSI resource period can be dynamically changed by a DL MAC CE.

### For Step 2 in the Air-Interface

The input data to the AI model for inference may be transmitted from the UE to the NW. Specifically in the example of AI-based beam management, such input data may be transmitted via any one or more of: UCI on PUCCH; UCI on PUSCH (Physical Uplink Shared Channel); UL MAC CE; or the like.

For such AI-based beam management function, any of the following datasets may be transmitted or signaled via any one of the channels or messages above as input data to the beam management AI model on the NW side for inference:
1. CSI measurement or SSB (synchronization signal block) measurement results;
2. Time information associated with the CSI-RS or SSBs measurement results;
3. UE trajectory information
4. Beam information such as CSI-RS ID and SSB ID;
5. UE location information
6. UE orientation information
7. UE speed information

### For Step 3 in the Air-Interface

Once the inference is performed by the NW based on the input data above, an action may be determined based on the inference. Such action, such as network configuration actions, if needed, may be performed by or informed to the UE. In the example of AI-based beam management function, such action based on inference from a beam management AI model may be any one or more of the following non-limiting list of operations:
1. A signaling to switch the UL/DL beam for one time instant.
2. Reconfigure the current the TCI state pool if there is only one entry in the pool.
3. A signaling to switch the UL/DL beams in a sequential way for a set of beams in a preconfigured time period.

The above operation can be indicated to the UE via any one of: downlink (DL) MAC CE; downlink control indication (DCI) message; and the like.

### For Step 4 in the Air-Interface

The feedback information for the AI-based functions may be generated by the UE and transmitted to the NW.

For the case of AI-based beam management function, such feedback information to the NW may include one of:
1. The inferred RSRP values of CSI-RS/SSBs for beam management.
2. The actual RSRP values of CSI-RS/SSBs for beams management.
3. The inferred best beams pattern for a time period.
4. The actual best beams pattern for a time period.

In some implementations, the feedback information above may be used for the NW to manage the life cycles of the AI model or AI functions. The life cycle management of the AI function or AI models may be based on the feedback information and various other schemes.

In some example implementations, the life cycle management of the AI functions or AI models may be time based. For example, an AI function or AI model management timer may be introduced and configured. Such a timer may be maintained at the NW side (e.g. either gNB or AI function layer/entity/OAM) that provisions the AI functions or AI models. Such a timer may be operated in the following manners:
1. Start the timer when receiving an indication that an AI model or an AI function is activated (e.g. at gNB side), or when the AI function layer/entity/OAM) of the NW sends an ACK in response to the AI function request to the gNB or the NW side sends the ACK to the UE. The timer may be restarted when the result of the performance evaluation showing the AI model performance is better than the pre-defined threshold.
2. When the timer expires: an indication, for example, may be sent by the gNB to the AI function layer/entity for deactivating the applied AI model or AI function. For another example, an indication may be sent from the AI function layer/entity to the gNB for disabling an AI-based beam management function/configuration.
3. Stop the timer when the AI function entity/layer receiving an indication from gNB for deactivating the AI model or AI function, or when the gNB receiving an indication from AI function entity/layer for disabling the AI-based beam management model or function (for an example beam management).

In some other example implementations, the life cycle management of the AI functions or AI models may be event based. In other words, a life cycle management action may be triggered by a preconfigured or predetermined occurrence of one or more events. For the example, these trigger events may include but are not limited to any one or more of:
1. For AI-based beam management function, when beam failure is detected for the BWP/serving cell(s) where the AI-based beam management is ongoing.
2. AI-based beam management function, when radio link failure is detected for the BWP/serving cell(s) where the AI-based beam management is ongoing.
3. deactivation of the BWP/serving cell(s) where the AI-based function is ongoing.
4. reception of the HO command.
5. Occurrence of Mac Reset.

Upon detecting and/or receiving the indication of the triggering events above, the NW may perform the operation of disabling the AI-based function or model such as the AI-based beam management function or model.

In yet some other example implementations, the life cycle management of the AI functions or AI models may be event based a performance evaluation of the AI model or function. The performance evaluation of the AI model may be implemented at either gNB or AI layer/entity by the comparison between an inference output of the AI model and an actual value corresponding to the inference. For example, for performance evaluation of AI-based beam management function, an AI-model inferred RSRP (Reference Signal Receive Power) values of one or more beams from the AI model and an actual measurement result of identical beams from legacy measurement may be compared to generate the performance evaluation.

The performance evaluation may be mainly used for measuring the currently applied AI model's performance. If the performance evaluation result shows that the current AI model is not sufficiently workable/ideal in the current network environment, some AI model life cycle management operation may be carried out by the NW. For example, based on the performance evaluation results, the current AI-model may be deactivated, the current AI model may be switch to a different AI-model; the current AI-model may be retrained, the current AI-model may be reinforcement trained, or the current AI-model may be fine-tuned, and the like.

In some implementations, for AI-based beam management function, in addition to the CSI resource/report configuration for the AI-based beam management, the NW may additionally configure one CSI/SSB resource set and associated CSI report for performance evaluation. And in some implementations, the period of this CSI resource/report may be longer than the CSI resource/report configured for AI-based beam management. In some implementation, in addition to the CSI-resource/report configuration for the AI-based management, the CSI-resource/report configuration for non-AI-based beam management can be adjusted for performance evaluation, for example, using one DL MAC CE and/or RRC reconfiguration to adjust the period of CSI report and/or CSI measurement for non-AI-based beam management.

### For Step 5 in the Air-Interface

In some implementations, the life cycle management operations of AI-based function on the UE side may include but are not limited to the following operation: disable the AI-based function; keep the AI-based function but adjust with some RRC reconfiguration, etc.

### For Step 1 in the AI Interface

Similar to the describe above for Step 0 in the air-interface, the AI function request sent from the gNB to the AI function/entity/layer may include but is not limited to at least one of the following information:
1. AI-based function information: to indicate the requested AI-based function from a set of functions group by index or function ID. For example, in this case, the identifier ‘0’ of the AI-based function may represent the AI-based spatial beam management, the identifier ‘1’ of the AI-based function may represent the AI-based temporal beam management function, etc.
2. Assistance information for AI model selection/training: to indicate what types of information that can be provided by UE for model selection or model training. For example, such model selection or training information may include a UE location information, speed information, direction information, or orientation information, and the like of the UE or wireless terminal device.

### For Step 3 in the AI Interface

the ACK from the AI function/entity/layer to the gNB in response to the AI-based function request may include at least one of the following information:
1. AI model information: to indicate an identifier of the AI model for the requested AI-based function. For example, there may be more than one offline AI models for AI-based beam management functions, and one of these models may be associated with a model ID to represent an AI model for the AI-based spatial beam management, whereas another model ID may represent another model for AI-based temporal beam management.
2. Input data type information for the AI model: to indicate the input data type. For instance, the different AI models may acquire various input data types. For example, some AI models may need UE location information, whereas some other AI model may need UE orientation information.
3. Output data of the model inference: in the AI-based spatial beam management case, the output data of the model inference may be the top-K beams information and associated RSRP values, K is equal to or greater than 1. In another implementation, the output data of the model inference may be the top-K beams and associated RSRP value for a timing period in which the top K beams and associated RSRP value is present for each timing point of the time period, the granularity of timing points in a time period being configurable. In some implementation, K may be configurable.
4. Performance evaluation related information such as requested information for performance evaluation for the selected AI model. Another example includes the configuration of performance evaluation information. In case of AI-based beam management, the performance evaluation related information may include the CSI/SSB RS resources and/or CSI report configuration.

### For Step 4 in the AI Interface

Input data from gNB to AI function entity/layer for model inference is similar to the input data described in step 2 of the air-interface above.

### For Step 5 in the AI Interface

Once the inference output is generated by the selected AI model, the inference output is provided from the AI function entity/layer to the gNB. In some implementation, the inference data may contain at least one of the following information:
1: The top-K best candidate beams with the RSPR for AI-based spatial beam management, K is equal to or larger than ‘1’, in some implementation, the K maybe configurable.
2: the beam patterns with the RSRP for AI-based temporal beam management, in some implementation, beam patterns maybe a set of the candidate UL/DL beams each beam maybe associated with a time information. In some implementation, one timing point may have more than one candidate beams.

### For Step 6 in the AI Interface

For the case of AI-based beam management function, the feedback information may include at least one of:
1. The inferred RSRP values of CSI-RS/SSBs for beam management
2. The actual RSRP values of CSI-RS/SSBs for beams management
3. The inferred best beams pattern for a time period
4. The actual best beams pattern for a time period.

### For Step 7 in the AI Interface

the AI model operation based on the feedback received in Step 6 may include at least one of the non-limiting list of the following operations:
1. AI model switch: Deactivate the applied AI model and activate another AI model
2. AI model deactivation: Deactivate the currently-applied AI model.

### Case 2: NW Side AI Model, Online Training

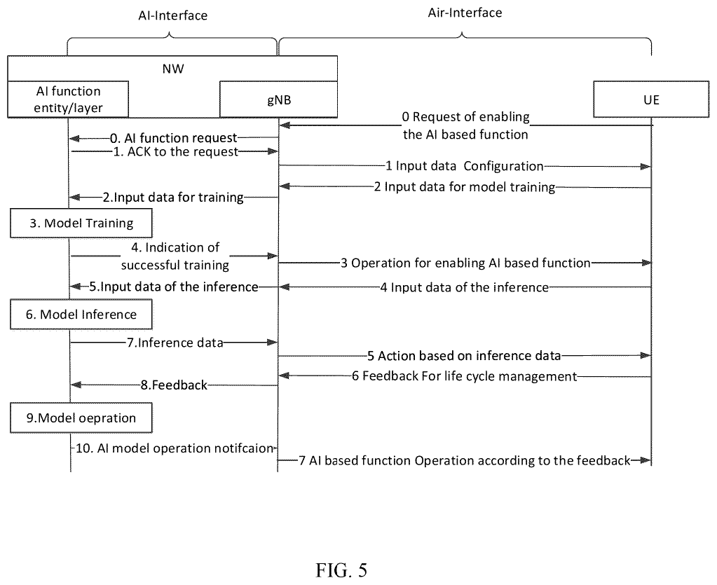

In this case, the AI model may be trained at NW side online. These AI models may be architectured by NW vendor, and the training process for the AI-model may be performed online with current training datasets. An example general procedure in terms of data and logic flow of information for this case is shown in FIG. 5.

Like case 1, the NW side may be further configured with a separate function, entity, layer, or OAM (Operation, Administration, and Management functions) that handle the AICS provisioning and configuration. Such entity may reside in core network shown in FIG. 1. Alternatively, it may be part of the access network. In some implementations, the such an entity may reside in the base station, such as a gNB as a separate function. In some other implementations, the AI entity and the gNB functions may be integral part of the base station. In such implementations, the information exchange via AI-interface will not be relevant and the operation of AI function entity/layer would be considered as gNB's operation. When the AI entity and the gNB are separately implemented (either functionally or physically), the communication interface therebetween (both data and control) may be referred to as AI interface, whereas the communication between the UE or wireless terminal device and the gNB or other base stations may be referred to as the air-interface, as shown in FIG. 5.

As further shown in FIG. 5, the example general procedure in the air-interface for case 2 may include:
Step 0: UE may send an indication of requesting the AI-based function or service to the NW. Alternatively, the NW determines that the AI-based function can be enabled.
Step 1: the NW transmits a configuration for the UE to report the input data for model training.
Step 2: the UE reports the input data for model training to the NW for model training.
Step 3: the NW may select an AI model for training/validating/testing with the input data, or select an undertrained AI model for reinforcement training with the input data. If the AI model is trained successfully, the NW may implement the operations for enabling AI-based function. The NW in the meanwhile may start the life cycle management of the AI model or AI function.
Step 4: the UE sends the input data for model inference to the gNB.
Step 5: the gNB takes an action according to the output of model inference.
Step 6: the UE feeds back the information to the gNB for AI model life management.
Step 7: the NW implements the operation of disabling the AI-based function once the model life management shows that the AI model is no longer sufficiently workable.

The example general procedure via AI-interface in FIG. 5 may include:
Step 0: the gNB sends a request for enabling an AI-based function to the AI entity/layer.
Step 1: the AI entity/layer may send an ACK in response to the AI-based function request to the gNB when receiving the AI-based function request and if the AI entity/layer have available AI models for the requested AI-based function. Otherwise, the AI entity/layer may send a NACK to the gNB, then the procedure ends.
Step 2: the gNB sends the input data for AI model training to the AI entity/layer.
Step 3: the AI entity/layer starts training/reinforcing/validating/testing the AI model. If the AI model training is successful, go to step 4. Otherwise, the AI entity/layer sends an indication that the training has failed to the gNB, and then the procedure ends.
Step 4: the AI entity/layer sends an indication that the AI model have been trained successful.
Step 5: the gNB sends the input data for model inference to the AI entity/layer.
Step 6: the AI entity/layer perform the inference with the received input data from gNB with the active AI model.
Step 7: the AI entity/layer send the inference output to gNB for AI-based beam management.
Step 8: The gNB send the feedback information to AI function entity/layer for AI model performance evaluation.
Step 9: the AI entity/layer determine the AI model operation (e.g. activation/deactivation, switch, re-training, fine-tuning) when receiving an indication of AI model failure from the gNB.
Step 10: the AI entity/layer sends the indication of AI model operation to the gNB for further operation of AI-based function by the gNB.

Below provides further detailed description of the steps above implemented in the air-interface.

### For Step 0 in the Air-Interface

The request of the AI-based function, such as beam Management may embedded/encapsulated in or carried by at least one of the following messages/signaling/formations:
1. uplink (UL) media access layer (MAC) control element (CE); UL MAC CE;
2. Uplink Control Information (UCI);
3. Scheduling request (SR)/physical uplink control channel (PUCCH) signaling with a format;
4. UE Assistance information (UAI), e.g., one form of uplink radio research control (RRC) signaling; or
5. UE capability signaling.

In any one of above alternative options for the request for AICS, at least one of the following information may be included in the request:
1. AI-based function information: to indicate the requested AI-based function from a list of functions (e.g. AI-based beam management, AI-based spatial beam management, AI-based temporal beam management, AI-based positioning, AI-based CSI feedback, etc.). Such AI-based functions may be represented by predefined indices or may be represented by predefined AI function IDs.
2. Assistance information for AI model selection/training: to indicate what types of information that can be provided by UE for model selection or model training. For example, such model selection or training information may include a UE location information, speed information, direction information, orientation information.

### In Step 1 in the Air-Interface

NW may configure the following configuration to UE:
1. CSI resources for beam management configuration. In some implementations, the CSI resources is for non-AI-based beam management.
2. CSI report for beam management configuration. In some implementations, the CSI report is for non-AI-based beam management.

### For Step 2 in the Air-Interface

In step 2, UE reports the CSI measurement result for beam management along with some other assistance information to NW as the model training input upon the configured configuration of CSI measurement in step 1.

### For Step 3 in the Air-Interface

For enabling the AI-based beam management, as an example, the operation from NW side may include at least one of the operations in the list of Step 1 in the air interface for case 1 above.

### For Step 4 in the Air-Interface

The input data of the AI model inference for beam management can be sent via: UCI on PUCCH, UCI on PUSCH, or UL MAC CE, for example.

For such AI-based beam management function, any of the following datasets may be transmitted or signaled via the channels or messages above as input data to the beam management AI model on the NW side for inference:
1. CSI measurement or SSB (synchronization signal block) measurement results;
2. Time information associated with the CSI-RS or SSBs measurement results';
3. Ue Trajectory Information;
4. Beam information; to indicate the beam with the CSI-RS ID or SSB ID;
5. UE location information;
6. UE orientation information;
7. Ue Speed Information.

For step 5 in the air-interface: Similar to step 3 in the air-interface in case 1.

### In Step 6 and 7 in the Air-Interface

These steps of case 2 are similar to step 4 and 5 in the air-interface in case 1.

In some example implementations, the life cycle management of the AI functions or AI models may be time based. For example, an AI function or AI model management timer may be introduced and configured. Such a timer may be maintained at the NW side (e.g. either gNB or AI function layer/entity/OAM) that provisions the AI functions or AI models. Such a timer may be operated in the following manners:
1. Start the timer when receiving an indication that an AI model or an AI function is successfully trained (e.g. at gNB side), or when sending an indication of the successful training to gNB (e.g. at AI function layer/entity side). The timer can be restarted when AI model is fine-tuned successfully. The timer may be restarted when the result of the performance evaluation showing the AI model performance is better than the pre-defined threshold.
2. When the timer expires: an indication, for example, may be sent by the gNB to the AI function layer/entity for deactivating the applied AI model or AI function if the timer is located at the gNB side. For another example, an indication may be sent from the AI function layer/entity to the gNB for disabling an AI-based beam management function/configuration if the timer is located at AI entity/layer.
3. Stop the timer when the AI function entity/layer receiving an indication from gNB for deactivating or retraining the AI model or AI function, or when the AI function entity/layer determines that the AI model or function is to be deactivated or retrained, or when the gNB receiving an indication from AI function entity/layer for disabling or retraining the AI-based beam management model or function (for an example beam management) or when the gNB determines AI model should be deactivated base on some events, such as received beam failure recovery request, SCell/BWP activation/deactivation, handover preparation, MAC reset, etc.

In some other example implementations, the life cycle management of the AI functions or AI models may be event based. In other words, a life cycle management action may be triggered by a preconfigured or predetermined occurrence of one or more events. For the example, these trigger events may include but are not limited to any one or more of:
1. For AI-based beam management function, when beam failure is detected for the BWP/serving cell(s) where the AI-based beam management is ongoing.
2. AI-based beam management function, when radio link failure is detected for the BWP/serving cell(s) where the AI-based beam management is ongoing.
3. deactivation of the BWP/serving cell(s) where the AI-based function is ongoing.
4. reception of the HO command.
5. Occurrence of Mac Reset.

Upon detecting the triggering events above, the NW may perform the operation of disabling the AI-based function or model such as the AI-based beam management function or model.

In yet some other example implementations, the life cycle management of the AI functions or AI models may be event based a performance evaluation of the AI model or function. The performance evaluation of the AI model may be implemented at either gNB or AI layer/entity by the comparison between an inference by the AI model and an actual measurement corresponding to the inference. For example, for performance evaluation of AI-based beam management function, an AI-model inferred RSRP (Reference Signal Receive Power) values of one or more beams from the AI model and an actual measurement result of identical beams from legacy measurement may be compared to generate the performance evaluation.

The performance evaluation may be mainly used for measuring the currently applied AI model's performance. If the performance evaluation result shows that the current AI model is not sufficiently workable/ideal in the current network environment, some AI model life cycle management operation may be carried out by the NW. For example, based on the performance evaluation results, the current AI-model may be deactivated, the current AI model may be switch to a different AI-model; the current AI-model may be retrained, the current AI-model may be reinforcement trained, or the current AI-model may be fine-tuned, and the like.

In some implementations, for AI-based beam management function, in addition to the CSI resource/report configuration for the AI-based beam management, the NW may additionally configure one CSI/SSB resource set and associated CSI report for performance evaluation. And in some implementations, the period of this CSI resource/report may be longer than the CSI resource/report configured for AI-based beam management. In some implementation, in addition to the CSI-resource/report configuration for the AI-based management, the CSI-resource/report configuration for non-AI-based management can be adjusted for performance evaluation, for example, using one DL MAC CE and/or RRC reconfiguration to adjust the period of CSI report and/or CSI measurement for non-AI-based function.

In some implementations, the life cycle management operations of AI-based function may include but are not limited to the following operation: disable the AI-based function; keep the AI-based function but adjust some RRC configuration for adapting to a new AI model, for AI model reinforcement training or fine-tuning, etc.

### In Step 0 in the AI Interface

the AI function request is including the at least one of the following information:
1. AI-based function information: to indicate the AI-based function from a set of functions group, for example, the identifier ‘0’ of the AI-based function is to represent the AI-based spatial beam management, the identifier ‘1’ of the AI-based function is to represent the AI-based temporal beam management, etc.
2. Assistance information for AI model selection/training: to indicate what types of information that can be provided by UE for model selection or model training. For example, such model selection or training information may include a UE location information, speed information, direction information, orientation information
3. AI model information: To indicate what kind of information can be provided by UE/gNB for AI model training/inference.

### In Step 1 in the AI-Interface

the ACK to the request may include at least one of the following information:
AI model information: the identifier of the AI model which indicates an AI model from a set of AI models.
Input data type for training: In the beam management case, the input data type for training may include a set of the information those are needed for model training, for one information set, at least one of the following information shall be contained
   a) CSI-RS/SSB measurement result for non-AI-based beam management.
   b) The time information associated with the CSI-RS/SSB measurement result
   c) The location information associated with the CSI-RS/SSB measurement result.
   d) The speed information associated with the CSI-RS/SSB measurement result.
   e) The orientation information associated with the CSI-RS/SSB measurement result.
Input data type for inference: in the beam management case, the input data type for training may include a set of the information those are needed for model training, for one information set, at least one of the following information shall be contained:
   a) CSI-RS/SSB measurement result for AI-based beam management.
   b) The time information associated with the CSI-RS/SSB measurement result.
   c) The location information associated with the CSI-RS/SSB measurement result.
   d) The speed information associated with the CSI-RS/SSB measurement result.
   e) The orientation information associated with the CSI-RS/SSB measurement result.
Output data of the model inference: in the AI-based spatial beam management case, the output data of the model inference may be the top-K beams information and associated RSRP values, K is equal to or greater than 1. In another implementation, the output data of the model inference may be the top-K beams and associated RSRP value for a timing period in which the top K beams and associated RSRP value is present for each timing point of the time period, the granularity of timing points in a time period being configurable. In some implementation, K may be configurable.
Performance evaluation related information such as requested information for performance evaluation for the selected AI model. Another example includes the configuration of performance evaluation information. In case of AI-based beam management, the performance evaluation related information may include the CSI/SSB RS resources and/or CSI report configuration.

### In Step 2 in the AI-Interface

For training a beam management AI model, the input data for online training, for example, may include at least one of the below information:
1. CSI-RS/SSB measurement result for beam management.
2. The time information associated with the CSI-RS/SSB measurement result.
3. The location information associated with the CSI-RS/SSB measurement result.
4. The speed information associated with the CSI-RS/SSB measurement result.
5. The orientation information associated with the CSI-RS/SSB measurement result.

### In Step 3 in the AI-Interface

For model training, for terminating the endless model training, there may be a timer for AI entity/layer to train a model, the timer may be associated with at least one of the following operations:
1. Start: model training is started. In one implementation, it can be started at the end of the ACK message to the request, or it can be started when successfully receiving very first input data for online training.
2. Stop: Model training is successfully terminated.
3. Expire: Consider the current model cannot be convergent, and trigger deactivate the AI model, send an indication to gNB and/or the AI entity/layer that the failure of the model training. The procedure ends.

### In Steps 5 and 6 in the AI-Interface

the input data of the inference is including at least one of the following information, for the example AI-based beam management model:
1. CSI-RS/SSB measurement result for AI-based beam management.
2. The time information associated with the CSI-RS/SSB measurement result.
3. The location information associated with the CSI-RS/SSB measurement result.
4. The speed information associated with the CSI-RS/SSB measurement result.
5. The orientation information associated with the CSI-RS/SSB measurement result.
   The input data may then be processed by the trained AI model to generate inference.

### In Step 7 in the AI-Interface

The inference data can be at least one of the following for the example AI-based beam management model:
1. The top-K best candidate beams with the RSRP for AI-based spatial beam management, where K is equal to or larger than ‘1’, in some implementation, the K maybe configurable.
2. the beam patterns with the RSRP value in a time period for AI-based temporal beam management, in some implementation, beam patterns maybe a set of the candidate UL/DL beams and each beam maybe associated with a time information in a time period. In some implementation, at one timing point more than one candidate beams are present.

### In Step 8 in the AI-Interface

The detail can be reference to above life cycle management part in case 1.

### In Step 9 in the AI-Interface

The model operation may include at least one of the following operations:
Deactivate the model
re-train the model
Switch the model to another
fine-tuning the model

### Case 3: UE Side Model, Offline Training

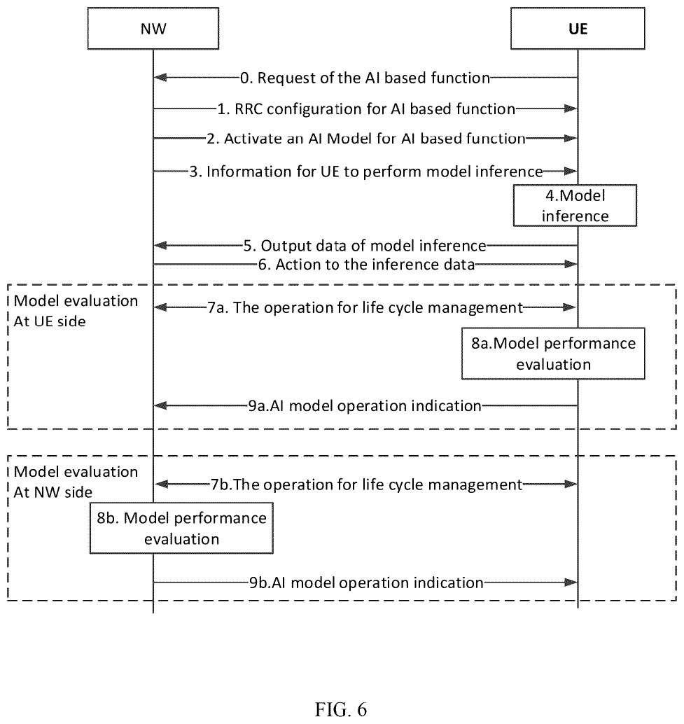

In this case, the AI model may be at UE side and trained offline. These AI models may be developed by UE or other vendors. An example general procedure in terms of data and logic flow of information is shown in FIG. 6.

As further shown in FIG. 6, the example general procedure for case 3 may include:
Step 0: the UE send a request to the NW for enabling the AI-based function.
Step 1: the NW configure the configuration of AI-based function to the UE via RRC signaling.
Step 2: the NW send a signaling to activate the AI model for the AI-based function.
Step 3: the NW send the information for the UE to perform the model inference.
Step 4: the UE obtain the input for model inference according to the information in step 3, and then obtain the inference from AI model.
Step 5: the UE send the inference to the NW for the action.
Step 6: the NW take an action according to the received inference.

If model performance evaluation of the AI model is performed at the UE side:
Step 7a: the NW and the UE start the operation for the AI model life cycle management.
Step 8a: the UE process the performance evaluation.
Step 9a: the UE send an indication to the NW for notifying the operation of the applied AI model according to the evaluation result.

If the performance evaluation of the AI model is performed at the NW side:
Step 7b: the NW and the UE start the operation for the AI model life cycle management.
Step 8b: the NW process the performance evaluation according to the received information from UE.
Step 9b: the NW send an indication to the UE for indicating the operation of the applied AI model according to the evaluation result.

### In Step 0

The request message can be via at least one of the following:
1. UCI
2. UE assistance information
3. UL MAC CE
4. UE capability signaling

For above message type, the following information may be contained:
1. The AI-based function information such as the AI-based function identifier, to indicate what the AI-based function is for request, which in this case, may be the AI-based beam management is requested.
2. The AI model information such as:
   a) the AI model identifier
   b) the processing time for AI model inference.
   c) the value T of time period for the life cycle of the AI model
   d) the input data type for model inference and/or training
   e) the output data type for model inference
   f) the suggestion of the RRC configuration for input data type, for instance, the period of CSI resources, the period of CSI reporting, etc.

### In Step 1

The RRC configuration for AI-based beam management may include at least one of the following contents:
1. RRC re-configuration for CSI measurement and report for non-AI-based beam management.
2. RRC configuration for CSI measurement and report for AI-based beam management.

### In Step 2

The activation of AI model for AI-based beam management can be done via:
1. DL MAC CE. In DL MAC CE, it shall include AI-based function ID and AI model ID.
2. RRC message, to activate an AI model via an enable flag, which may be merged into step 1.

### In Step 3

The information for UE to perform model inference is the CSI-RS/SSB reference signal for AI-based beam management.

### In Step 4

The UE make an inference according to measurement result of the CSI-RS/SSB reference signal in step 3.

### In Step 5 and 6

The output of the model inference can be at least one of the following information:
1. The top-K best beams and/or associated RSRP value, K is configurable and can be equal to and greater than 1.
2. The whole beams information and/or associated RSRP values.
3. A series of top-K beams and/or associated RSRP value for a time period, K is configurable and can be equivalent to and greater than 1.
   a) The time period can be indicated by M consecutive CSI resources and/or CSI report periods, M can be configurable and can be equivalent to and greater than 1.

In some implementations, if K>1, the action to inference data is including the following:
1. Send a DL MAC CE of dynamically adjusting the UL/DL beam to UE according to the received inference information for one shot.
2. Send a DL MAC CE of dynamically adjusting a series of the UL/DL beam within a time period to UE according to the received inference information.
   a) The time period can be indicated by M consecutive CSI resources and/or CSI report periods, M can be configurable and can be equivalent to and greater than 1.

In some implementations, if K=1, the action to inference data is including the following, the action to inference data is to adjust the UL/DL beam at NW side.

### Step 7a, 7b, 8a, 8b for Life Cycle Management

For the timer-based life cycle management, a timer is configured to UE for life cycle management for an AI model of an AI-based beam management. The timer may be started/restarted upon at least one of the following events:
1. The reception of the activation signaling for the AI model.
2. The transmission of the feedback information for performance evaluation of the AI model.
3. The one indication of performance evaluation is received showing or the performance evaluation is determined that the current AI model is still suitable. In some implementations, to determine whether the AI model is suitable or not upon the differences between the average/the best inferred RSRP values of one or more beams and the average/the best actual RSRP values of the identical beams. If the differences are less than a pre-configured/defined threshold, the AI model may be considered as suitable. If the differences are equivalent to or greater than a per-configured threshold, the AI model maybe considered as not suitable.

In some implementations, the timer shall be stopped upon at least one of the following events: the reception of the deactivation signaling for the AI model, and/or the AI model is considered as deactivated.

In some implementations, when the timer is expired, the AI model is considered as deactivated.

In some implementations, the AI model life cycle management may be event based. For example, the applied AI model for the AI-based function will be considered as not workable by at least one of the following events
1. Beam failure is detected for the BWP/serving cell(s) where the AI model is applied.
2. Radio link failure is detected for the BWP/serving cell(s) where the AI model is applied.
3. Deactivation of the BWP/serving cell(s) where the AI model is applied.
4. Reception of the HO command.
5. Mac Reset.

For above events, AI model is considered as deactivated and/or the timer related to the AI model is considered as expired or shall be stopped, if any.

In some implementations, the AI model life cycle management may be based on AI performance evaluation. The performance evaluation is used for evaluating the workability of an AI model which can be performed at either NW side or UE side. In one example implementation, by comparison the inferred RSRP value of one or more beams and the actual RSRP value of the identical beams.

In one implementation, if the differences between the inferred RSRP value of one or more beams and the actual RSRP value of the identical beams are less than a pre-configured/defined threshold, the AI model may be considered as workable. If the differences are equivalent to or greater than a per-configured threshold, the AI model may be considered as not workable. In some implementation, the judgment of the workability for an AI mode may not rely on the one-shot comparison. It may be configured with a value ‘N’ as maximum times. The AI model can be considered as failed/unsuitable when N continuous differences between the inferred averaged/best RSRP value of one or more beams and the actual averaged/best RSRP value of the identical beams are equal to or greater than a pre-configured threshold.

If the performance evaluation is performed at NW side, UE may need to report the feedback information for performance evaluation. The feedback information includes the inferred RSRP value of one or more beams and the actual RSRP value for the identical beams. The inferred RSRP value of one or more beams can be obtained from the output of the model inference. The actual RSRP value for the identical beams can be obtained from the CSI measurement/report for non-AI-based beam management.

If performance evaluation shows that the AI model is no longer workable, the NW may send a deactivation signaling for the current AI model to the UE or the NW may send an indication to the UE for switching the applied AI model to another.

If the performance evaluation is performed at UE side, in addition to the SSB/CSI-RS for AI-based beam management, the NW may need to configure the SSB/CSI RS associated with the beams to the UE for performing the measurement for obtaining the actual RSRP value.

If the performance evaluation shows that the current AI model is no longer workable, the AI model will be deactivated by the UE, and then the UE send the indication to the NW for disabling the AI-based function. In another implementation, the UE sends the indication to the NW about the evaluation result. It may be up to the NW to determine the AI model operation, and then the NW sends the AI model operation indication to the UE.

Regarding the AI model operation, it may include the at least one of the followings:
1. Deactivate the applied AI model.
2. Switch the applied AI model to another.

### Case 4: UE Side Model, Online Training

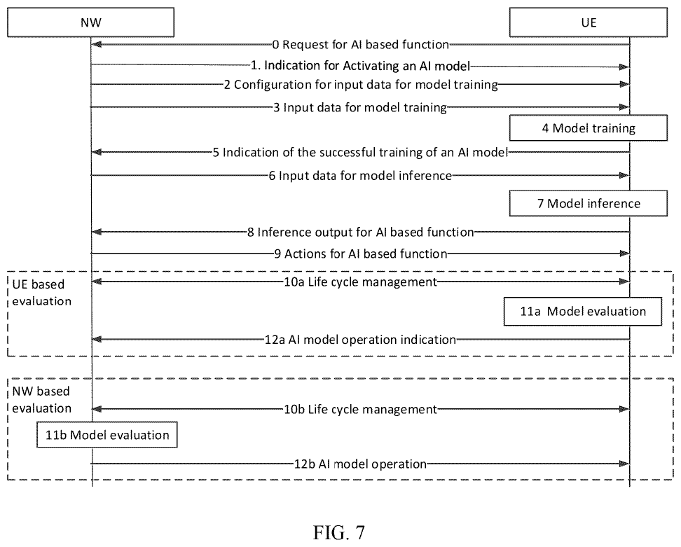

In this case, the AI model may be trained at UE side online. These AI models may be developed by UE vendor. An example general procedure in terms of data and logic flow of information is shown in FIG. 7.

As further shown in FIG. 7, the example general for case 4 may include:
Step 0: the UE send a request to the NW for enabling the AI-based function and/or AI model training.
Step 1: the NW send an indication to UE for activating an AI model.
Step 2: the NW configure the configuration of input data for the model training to UE via RRC signaling.
Step 3: the NW send the signaling for input data for model training.
Step 4: the UE start model training with the input data.
Step 5: the UE send an indication of the successful training of an AI model to the NW.
Step 6: the NW send the information for input data for model inference.
Step 7: the UE obtain the input for model inference according to the information in step 6, and then obtain the inference from AI model.
Step 8: the UE send the inference to the NW for the action.
Step 9: the NW take an action according to the received inference.

If performance evaluation of the AI model is performed at the UE side:
Step 10a: NW and UE start the operation for the AI model life cycle management.
Step 11a: UE process the performance evaluation.
Step 11a: UE send an indication to NW for notifying the operation of the applied AI model according to the evaluation result.

If performance evaluation of the AI model is performed at the NW side:
Step 10b: NW and UE start the operation for the AI model life cycle management.
Step 11b: NW process the performance evaluation according to the received information from UE.
Step 12b: NW send an indication to UE for the operation of the applied AI model according to the evaluation result.

### In Step 0

The request message can be at least one of the following information:
1. UCI
2. UE assistance information
3. UL MAC CE
4. UE capability signaling.

For above message type, the following information may be contained:
1. The AI-based function information such as the AI-based function identifier
2. The AI model information such as:
   a) AI model identifier.
   b) the time requirement for AI model inference.
   c) The time requirement for AI model training.
   d) the time value for life cycle of the AI model.
   e) the input data type for model inference and/or training.
   f) the output data type for model inference.
   g) the suggested configuration for input data type (e.g. inference and/or training), for instance, the period of CSI resources, the period of CSI reporting and the number of periods for inference, etc.

### In Step 1, Step 2 and Step 3

The RRC configuration for input data of model training includes the RRC configuration for CSI measurement and report of beam management, and consequently, the input data for model training is the measurement result of the CSI/SSB for beam management. In some implementation of step 1, NW may activate an AI model for training via either DL MAC CE or RRC message according to the request information in step 0.

### In Step 4

For model training, there may be a timer introduced for the model training. The timer is used for avoiding the endless training which is caused by the AI model cannot be convergent for a long time. The operation of the timer is shown as below:
1. The timer is started upon receiving the indication to activate the AI model for online training/re-training/fine-tuning.
2. The timer is stopped upon receiving the indication to deactivate the AI model for online training, or the AI model is determined to be trained successfully (e.g. send an indication to NW for successful model training).
3. AI model training is considered as failed if the timer is expired, and in some implementation, UE need to send a message to NW for indicating the failure of the model training.
   In Step 5 UE sends an indication to NW when the AI mode is trained successfully. The indication can be at least one of the following format:
1: UL MAC CE
2: UCI
3: UE Assistance information

### In Step 6

The input data for model inference is the CSI-RS/SSB reference signal for AI-based beam management in the example case of AI-based beam management.

### In Step 7, Step 8, Step 9

The output of the model inference can be at least one of the following information:
1. The top-K beams and associated RSRP values, K is configurable and can be equivalent to and greater than 1.
2. The whole beam information and associated RSRP values.
3. A series of top-K beams and associated RSRP value for a time period, K is configurable and can be equivalent to and greater than 1.
   a) The time period can be indicated by M consecutive CSI resources and/or CSI report periods, M can be configurable and can be equivalent to and greater than 1.

In some implementations, if K>1, the action to inference data at the NW may include:
1. Send a DL MAC CE or DCI for dynamically adjusting the UL/DL beam to UE according to the received inference information for one shot.
2. Send a DL MAC CE or DCI for dynamically adjusting a series of the UL/DL beam within a time period to UE according to the received inference information.

In some implementations, the time period can be indicated by M consecutive CSI resources and/or CSI report periods, M can be configurable and can be equivalent to and greater than 1.

In some implementations, if K=1, it means the action to inference data at both NW and UE side is to adjust the UL/DL beam automatically according to the inference output for one shot or for a time period.

### In Steps 10, 11, 12 for Life Cycle Management

For the timer-based life cycle management, a timer is configured to UE for life cycle management of an AI model for an AI-based function. The timer shall be started/restarted upon at least one of the following events:
1. The reception of the activation signaling for AI model inference and/or training of AI-based beam management.
2. The feedback information is sent to NW for performance evaluation of the activated AI mode.

In some situations, indication of performance evaluation may be received showing that the current AI model is still suitable. Alternatively, the performance evaluation of the activated AI model determines that the current AI model is still suitable. In some implementations, whether the AI model is suitable or not may be determined based on the differences between the average/the best inferred RSRP values of one or more beams and the average/the best actual RSRP values of the corresponding beams. If the differences are less than a pre-configured/defined threshold, the AI model may be considered as suitable. If the differences are equivalent to or greater than a per-configured threshold, the AI model may be considered as not suitable.

In some implementations, the timer may be stopped upon at least one of the following events:
1. The reception of the deactivation signaling for the AI model.
2. The AI model is considered as deactivated by some kind event.

In some implementations, when the timer is expired, the AI model is considered as deactivated.

In some implementations, the AI model life cycle management may be event based, and the applied AI model for the AI-based function may be considered as not workable by at least one of the following events:

1. Beam failure is detected for the BWP/serving cell(s) where the AI model is applied.
2. Radio link failure is detected for the BWP/serving cell(s) where the AI model is applied.
3. Deactivation of the BWP/serving cell(s) where the AI model is applied.
4. Reception of the HO command.
5. MAC Reset.

In some implementations, for above events, AI model is considered as deactivated and/or the timer related to the AI model is considered as expired, if any.

In some implementations, the AI model life cycle management may be based on AI model performance. For the example case of AI-based beam management, the performance evaluation may be used for evaluating the workability of the applied AI model which can be performed at either NW side or UE side by comparison the inferred RSRP value of one or more beams and the actual RSRP value of the identical beams.

In one implementation, if the differences between the inferred RSRP value of one or more beams and the actual RSRP value of the identical beams are less than a pre-configured/defined threshold, the AI model may be considered as workable. If the differences are equivalent to or greater than a per-configured threshold, the AI model may be considered as not workable. In some implementations, the judgment of the workability for an AI mode may not rely on the one-shot comparison, it may be configured with a value ‘N’ as maximum times, The AI model can be considered as failed/unsuitable when N continuous differences between the inferred averaged/the best RSRP value of one or more beams and the actual averaged/the best RSRP value of the identical beams are equal to or greater than a pre-configured threshold.

If the performance evaluation is performed at the NW side, the UE may need to report the feedback information for performance evaluation. The feedback information may include the inferred RSRP value of one or more beams and the actual RSRP value for the identical beams. The inferred RSRP value of one or more beams can be obtained from the output of the model inference. The actual RSRP value for the identical beams can be obtained from the CSI measurement/report for beam management.

If performance evaluation shows that the AI model is no longer workable, the NW may send:
1. a deactivation signaling for the current AI model to the UE, or
2. the NW may send an indication to the UE for switching the applied AI model to another; or
3. the NW may send an indication to the UE for fine-tuning the applied AI model; or
4. the NW may send an indication to the UE for re-training the applied AI model.

In some implementations, if the performance evaluation is performed at UE side, in addition to the SSB/CSI-RS for AI-based beam management, the NW need to configure the SSB/CSI RS associated with the beams to the UE for performing the measurement for obtaining the actual RSRP value.

If the performance evaluation shows that the current AI model is no longer workable, the AI model will be deactivated by UE, and then UE send the indication to NW for disabling the AI-based function, in another implementation, UE send the indication to NW about the evaluation result, it is up to NW to determine the AI model operation, and then NW send the AI model operation indication to UE. Regarding the AI model operation, it may include the followings:
1. Deactivate the applied AI model.
2. Switch the applied AI model to another.
3. Re-train the applied AI model.
4. Fine-tune the applied AI model.

### Case 5: Two-side Models, Offline Training Only

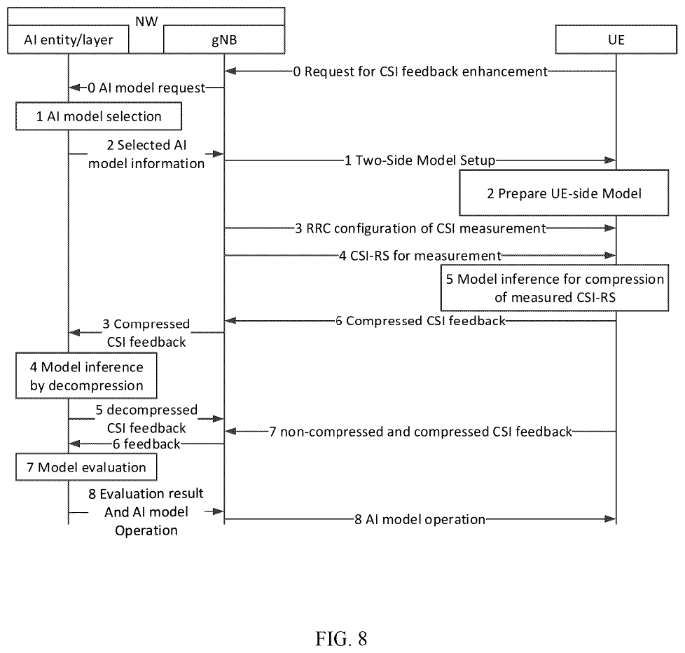

In this case, the AI model may be located at both the UE and NW side and the model may be offline trained. An example general procedure in terms of data and logic flow of information is shown in FIG. 8.

In some implementations, the NW side may be further configured with a separate function, entity, layer, or OAM (Operation, Administration, and Management functions) that handle the AICS provisioning and configuration. Such entity may reside in core network shown in FIG. 1. Alternatively, it may be part of the access network. In some implementations, the such an entity may reside in the base station, such as a gNB as a separate function. In some other implementations, the AI entity and the gNB functions may be integral part of the base station. In such implementations, the information exchange via AI-interface will not be relevant and the operation of AI function entity/layer would be considered as gNB's operation. When the AI entity and the gNB are separately implemented (either functionally or physically), the communication interface therebetween (both data and control) may be referred to as AI interface, whereas the communication between the UE or wireless terminal device and the gNB or other base stations may be referred to as the air-interface, as shown in FIG. 8.

As further shown in FIG. 8, the example general procedure in the air-interface for case 5 may include:
Step 0: the UE send a request for enabling AI-based CSI feedback enhancement.
Step 1: the NW select a two-side AI model (e.g. AI model pair) for CSI feedback enhancement, and send the AI model information for compressing CSI feedback or send an indication for activating an AI model for compressing CSI feedback to the UE.
Step 2: the UE may activate a pre-stored corresponding AI model for compressing CSI feedback according to the received indication in step 1 or install the AI model after receiving the AI model information from the NW.
Step 3: the NW send the configuration of CSI measurement/report to the UE for AI-based CSI feedback enhancement.
Step 4: the NW send the CSI-RS for measurement to the UE.
Step 5: the UE perform measurement of CSI-RS and compress the CSI feedback with the UE side AI model inference for compressing CSI feedback.
Step 6: the UE send the compressed CSI feedback to the NW.
Step 7: the UE send the compressed CSI feedback and non-compressed CSI feedback in a certain manner to NW for this two-side model performance evaluation.
Step 8: the NW send the AI model operation to UE according to the evaluation result, if needed.

The general procedure for AI-interface in case the NW-side AI model staying in the AI entity includes:
Step 0: the gNB send a request for enabling AI-based CSI feedback enhancement.
Step 1: the AI entity/layer select the two-side AI model for the requested function.
Step 2: the AI entity/layer send the AI model information to the gNB.
Step 3: the gNB send the compressed CSI feedback to the AI entity as the input of the model inference.
Step 4: the AI entity obtain the compressed CSI feedback and decompress the compressed CSI feedback with the NW-side AI model inference.
Step 5: the AI entity send the decompressed CSI feedback to the gNB.
Step 6: the AI entity receive the feedback information for performance evaluation from the gNB
Step 7: the AI entity perform the performance evaluation to generate evaluation results according to the feedback information which includes received compressed CSI feedback and non-compressed CSI feedback.
Step 8: the AI entity send the AI model operation to the gNB according to the evaluation result, if needed.

### For Step 0 in the Air-Interface

The request message for enabling the AI-based CSI feedback can be via at least one of the following:
1. UAI
2. UCI
3. UL MAC CE
4. UE capability signaling

With above information, it may contain at least one of the following information:
1. AI-based function information: to identify an AI-based function from a set of AI-based functions, in this case, the AI-based function information is to represent the AI-based CSI feedback.
2. At least one of the following AI model related information:
   A) AI Model Id.
   b) AI model complexity requirement.
   c) AI model type, including the DNN (deep-learning neural network), CNN (convolutional neural network), etc.
   d) Input data related information for the AI model.
   e) Output data related information for the AI model.
   f) Whether to support the online reinforcement training or fine-tuning.

### For Step 1 and Step 2 at Air-Interface

The AI model derivation may be at UE side. There may be two example solutions:
1. Direct AI model transfer.
   a) In step 2, UE need to download the AI model from NW for compressing CSI-RS feedback.
2. Activate an AI model for compressing CSI feedback from a pre-stored AI model list according to the received indication in step 1.
   a) In step 2, UE need to activate the indicated UE-side AI model for compressing CSI-RS feedback by the received information from NW. In some implementation, the indication may be included a DL MAC CE, or a DCI.

### For Step 7 at Air-Interface

In some implementation of the UE send the compressed and/or non-compressed CSI feedback, at least one of the following manners maybe adopted:
1: Time periodic, there is CSI-report configuration for non-compressed CSI feedback configured with a certain time period ‘T’ configured for UE to send the non-compressed CSI feedback to NW. In this implementation, the period value for reporting non-compressed CSI feedback maybe multiple integral times of the period value for reporting the compressed CSI feedback.
2: Semi-persistent time periodic, in one implementation, there is more than one CSI report configuration configured with different time period ‘T’ configured for UE to send the non-compressed CSI feedback to NW, each CSI report configuration can be activated/deactivated by a DL MAC CE. In another implementation, there is one CSI report configuration for UE to send non-compressed CSI feedback, and the time period configured in such CSI report configuration may be dynamically adjusted by a DL MAC CE or DCI.
3: Time aperiodic, NW can send a DCI and/or DL MAC CE to trigger the compressed and/or non-compressed CSI report for UE to send the non-compressed CSI feedback anytime.

For performing the life cycle management, in a time period T, the UE may need to send the non-compressed CSI feedback along with the compressed CSI feedback to the NW for NW to process the applied AI model's performance evaluation. The AI model operation maybe determined by NW upon the differences between the decompressed CSI feedback and non-compressed CSI feedback.

In some implementation for processing the applied AI model's performance evaluation. If the differences between the non-compressed CSI feedback and de-compressed CSI feedback is equivalent to or larger than a pre-defined/configured threshold with N continuous times or with N times in a certain time period M, the two-side AI model are considered as no longer workable. In one implementation, N can be configurable, and the value of the N may be equal to or lager than 1. In one implementation, the time period M is configurable. Otherwise, the two-side AI model are considered as workable.

In some example implementations, the life cycle management of the AI functions or AI models may be time based. For example, an AI function or AI model management timer may be introduced and configured. Such a timer may be maintained at the NW side (e.g. either gNB or AI function layer/entity/OAM) that provisions the AI functions or AI models. Such a timer may be operated in the following manners:
1. Start the timer when receiving an indication that an AI model or an AI function is activated (e.g. at gNB side), or when the AI function layer/entity/OAM) of the NW sends an ACK in response to the AI function request to the gNB or the NW side sends the ACK to the UE. The timer may be restarted when the result of the performance evaluation showing the AI model performance is better than the pre-defined threshold.
2. When the timer expires: an indication, for example, may be sent by the gNB to the AI function layer/entity for deactivating the applied AI model or AI function. For another example, an indication may be sent from the AI function layer/entity to the gNB for disabling an AI-based CSI feedback function/configuration.
3. Stop the timer when the AI function entity/layer receiving an indication from gNB for deactivating the AI model or AI function, or when the gNB receiving an indication from AI function entity/layer for disabling the AI-based CSI feedback model or function (for an example CSI feedback).

### For Step 8 at Air-Interface

The NW may consider the AI model related operation according to the evaluation result based on the received decompressed CSI feedback and compressed CSI feedback. The AI model operation is at least one of the following if the performance evaluation showing that the applied AI mode not workable/suitable
   a) Deactivation the two-side AI model
   b) Switch the two-side AI model to another, and then implement the new two-side AI model from step 1 in air-interface.

### Case 6: Two-Side Models, Online Training

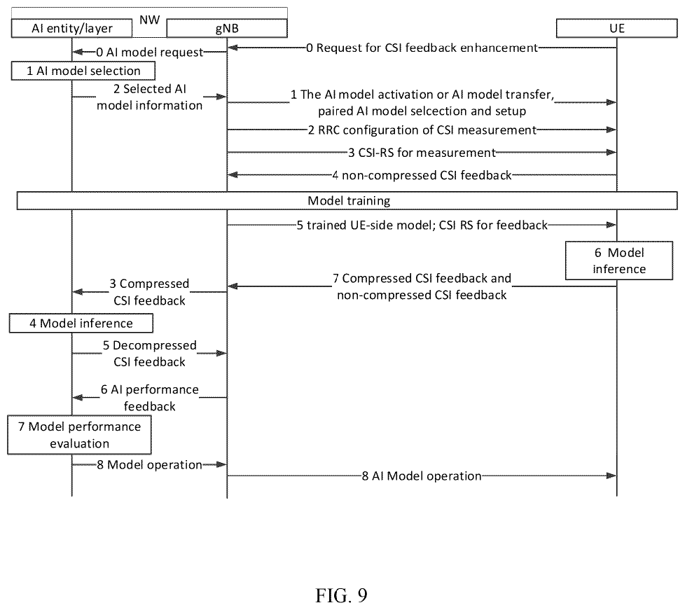

In this case, the AI model may be located at both the UE and NW side and the model may be online trained. An example general procedure in terms of data and logic flow of information is shown in FIG. 9.

For two-side model training In some implementation, either NW or UE perform the two-side model training (e.g. AI model for decompression, AI model for compression) with the input training data, and after the two-side AI model are successfully trained, NW should transfer the UE-side AI model to UE if NW perform the two-side model training, or UE should transfer the NW-side AI model to NW if UE perform the two-side model training.

In some implementations, the NW and the UE start training the AI model (e.g. AI model for decompression, AI model for compression) simultaneously, In some implementations, the NW and the UE start training the corresponding AI model in a sequential way, for instance, UE start training the UE-side AI model first, and after UE successfully training the AI model, UE may have two ways for NW to train the NW-side AI model.

In some implementations, the UE-side AI model is transferred to the NW, and the UE send the input value for UE side AI model inference to the NW for NW-side AI model training, NW will perform the NW-side AI model training with the output of the UE-side model inference and input of the UE-side model inference.

In a second manner, the UE always send an input of the UE-side model inference and output of the UE-side model inference to NW for training the NW-side AI model until the successful NW-side AI model training at NW-side.

In some implementations, a timer may be configured for controlling the AI model training at each side. A timer maybe started when the AI model start training, a timer may be stopped when the AI model training is successful, and the model training would be considered as failed due to the expiration of the timer.

In some implementations, the NW side may be further configured with a separate function, entity, layer, or OAM (Operation, Administration, and Management functions) that handle the AICS provisioning and configuration. Such entity may reside in core network shown in FIG. 1. Alternatively, it may be part of the access network. In some implementations, the such an entity may reside in the base station, such as a gNB as a separate function. In some other implementations, the AI entity and the gNB functions may be integral part of the base station. In such implementations, the information exchange via AI-interface will not be relevant and the operation of AI function entity/layer would be considered as gNB's operation. When the AI entity and the gNB are separately implemented (either functionally or physically), the communication interface therebetween (both data and control) may be referred to as AI interface, whereas the communication between the UE or wireless terminal device and the gNB or other base stations may be referred to as the air-interface, as shown in FIG. 9.

As further shown in FIG. 9, the example general procedure in the air-interface for case 5 may include:
Step 0: the UE send a request for enabling the AI-based CSI feedback enhancement.
Step 1: the NW select a two-side AI model for the AI-based CSI feedback enhancement according to the UE request information.
Step 2: the NW configure the CSI configuration for AI model training.
Step 3: the NW send the CSI-RS for measurement to the UE.
Step 4: UE report the non-compressed CSI feedback to NW, and then the NW start training the two-side AI model with the non-compressed CSI feedback.
Step 5: After successful training of two-side AI model for CSI feedback enhancement at NW side, the NW send UE side AI model of two-side AI model to UE. UE install the received model. NW sends CSI RS for feedback to UE for generating input data to the UE-side model.
Step 6: the UE compress the CSI-RS feedback with the UE-side AI model as the model inference output.
Step 7: the UE send the compressed CSI feedback to the NW, and the NW consider the compressed CSI feedback as input of the NW side AI model, and deduce the decompressed CSI feedback. The UE also send the non-compressed CSI feedback information in a certain manner for AI model performance evaluation.
Step 8: the NW perform the performance evaluation and obtain the AI model operation according to the evaluation result, and then send the AI model operation message to the UE, if needed.

The general procedure for AI-interface include in case of the NW-side AI model staying in AI entity:
Step 0: the gNB send a request of the AI-based CSI feedback to the AI entity/layer.
Step 1: the AI entity select an AI model for training.
Step 2: the AI entity send the selected AI model information to the gNB, AI entity start model training.
Step 3: After the successful AI model training, the gNB send the compressed CSI feedback to the AI entity/layer.
Step 4: the AI entity decompress the CSI feedback with decompression AI model.
Step 5: the AI entity send the decompressed CSI feedback to the gNB.
Step 6: the gNB send the feedback for the performance evaluation to the AI entity.
Step 7: the AI entity perform the performance evaluation for the applied the AI model.
Step 8: the AI entity perform the operation of the two-side AI model according to the result of the evaluation.

### For Step 0 at Air-Interface

The request message for enabling the AI-based CSI feedback can be via at least one of the following:
1. UAI
2. UCI
3. UL MAC CE
4. UE capability signaling.

With above information, it may contain at least one of the following information:
1. AI-based function information: to identify an AI-based function from a set of AI-based functions, in this case, the AI-based function information is to represent the AI-based CSI feedback.
2. AI Model Id.
3. AI model complexity requirement.
4. AI model type, including the DNN, CNN, etc.
5. Input data related information for the AI model.
6. Output data related information for the AI model.
7. Whether to support the online reinforcement training or fine-tuning.

### For Step 7 at Air-Interface

In some implementation of the UE send the compressed and/or non-compressed CSI feedback, at least one of the following manners maybe adopted:
1: Time periodic, there is CSI-report configuration for non-compressed CSI feedback configured with a certain time period ‘T’ configured for UE to send the non-compressed CSI feedback to NW. In this implementation, the period value for reporting non-compressed CSI feedback maybe multiple integral times of the period value for reporting the compressed CSI feedback.
2: Semi-persistent time periodic, in one implementation, there is more than one CSI report configuration configured with different time period ‘T’ configured for UE to send the non-compressed CSI feedback to NW, each CSI report configuration can be activated/deactivated by a DL MAC CE. In another implementation, there is one CSI report configuration for UE to send non-compressed CSI feedback, and the time period configured in such CSI report configuration may be dynamically adjusted by a DL MAC CE or DCI.
3: Time aperiodic, NW can send a DCI and/or MAC CE to trigger the compressed and/or non-compressed CSI report for UE to send the non-compressed CSI feedback anytime.

For model life cycle management, in a time period T, the UE may need to send the non-compressed CSI feedback along with the compressed CSI feedback to the NW for NW to process the applied AI model's performance evaluation. The AI model operation maybe determined by NW upon the difference value between the decompressed CSI feedback and non-compressed CSI feedback.

In some implementation for processing the applied AI model's performance evaluation. If the differences between the non-compressed CSI feedback and de-compressed CSI feedback is equivalent to or larger than a pre-defined/configured threshold with N continuous times or with N times in a certain time period M, the two-side AI model are considered as no longer workable. In one implementation, N can be configurable, and the value of the N may be equal to or lager than 1. Otherwise, the AI model for both sides are considered as workable.

In some implementation, there may be more than one threshold are pre-defined and/or pre-configured for determining the different operation of the AI model, for example, there are two threshold value A and B, and A<B, if the difference is larger than a threshold A but less than threshold B, the AI model can be fine-tuned online, the AI-based function can be kept as it is. If the value of the difference is larger than threshold B, the AI model shall be re-trained.

In some example implementations, the life cycle management of the AI functions or AI models may be time based. For example, an AI function or AI model management timer may be introduced and configured. Such a timer may be maintained at the NW side (e.g. either gNB or AI function layer/entity/OAM) that provisions the AI functions or AI models.

Such a timer may be operated in the following manners:
1. Start the timer when receiving an indication that an AI model or an AI function is activated (e.g. at gNB side), or when the AI function layer/entity/OAM) of the NW sends an ACK in response to the AI function request to the gNB or the NW side sends the ACK to the UE. The timer may be restarted when the result of the performance evaluation showing the AI model performance is better than the pre-defined threshold.
2. When the timer expires: an indication, for example, may be sent by the gNB to the AI function layer/entity for deactivating the applied AI model or AI function. For another example, an indication may be sent from the AI function layer/entity to the gNB for disabling an AI-based CSI feedback function/configuration.
3. Stop the timer when the AI function entity/layer receiving an indication from gNB for deactivating the AI model or AI function, or when the gNB receiving an indication from AI function entity/layer for disabling the AI-based bCSI feedback model or function (for an example CSI feedback).

### For Step 8 at Air-Interface

The NW may consider the two-side AI model related operation for CSI feedback enhancement according to the evaluation result. The AI model operation is as following:
1. Deactivation of the two-side AI model.
2. Switch the current two-side AI model to another.
3. Fine-tune the two-side AI model.
4. Re-train the two-side AI model.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method, by at least one wireless network node, comprising:
activating an Artificial Intelligence (AI) network configuration mode in response to receiving a request for AICS (AI configuration service) from a wireless terminal device;
determining a network-side AI model according to the request for AICS;
receiving a set of input data items to the network-side AI model from the wireless terminal device;
determining a network configuration action (NCA) based on an inference from the network-side AI model based on the set of input data items;
transmitting the NCA or an indication for the NCA to the wireless terminal device;
receiving an AI feedback data item from the wireless terminal device, the AI feedback data item being generated by the wireless terminal device based on a deployment outcome of the NCA according to the indication; and
preforming at least one AI network configuration management task according to the AI feedback data item.

2. The method of claim 1, wherein the request for AICS is implemented by one of:
an uplink Media Access Control (MAC) control element (CE) from the wireless terminal device;
an uplink control information (UCI) message from the wireless terminal device;
a physical uplink control channel (PUCCH) scheduling request (SR) from the wireless terminal device;
a user equipment (UE) assistance information in a radio resource control (RRC) message from the wireless terminal device; or
a capability signaling of the wireless terminal device.

3. The method of claim 2, wherein the request for AICS comprises at least one of:
an AI function indicator for indicating an AI configuration function among a plurality of AI configuration functions, the plurality of AI configuration functions comprising at least:
AI-based spatial beam management configuration function;
AI-based temporal beam management configuration function; and
AI-based CSI feedback configuration function; or
AI-assistant information for network-side AI model selection or training comprising at least one of:
location information of the wireless terminal device;
speed information of the wireless terminal device;
direction information of the wireless terminal device; or
device orientation information of the wireless terminal device.

4. The method of claim 1, wherein activating the AI network configuration mode comprises one of:
switching from a non-AI channel state measurement configuration to an AI-based channel state measurement configuration by at least one of:
deactivating a semi-periodic CSI report configuration associated with a set of non-AI-based beam management CSI resources;
activating a semi-periodic CSI report configuration associated with a set of predefined AI-based beam management CSI resources;
enabling or adding a periodic CSI report configuration associated with a predefined set of CSI resources for AI-based beam management via RRC reconfiguration; or
disabling or removing a periodic CSI report configuration associated with a set of CSI resources for non-AI-based beam management via the RRC reconfiguration; or
switching, for a specific channel state measurement configuration, from a non-AI channel state resource set to an AI-based channel state resource set by at least one of:
dynamically switching CSI resource associated with CSI report configuration from AI to non-AI using a downlink MAC CE;
dynamically changing a CSI report period value associated with the specific channel state measurement configuration by the downlink MAC CE; or
dynamically change a CSI resource period associated with the specific channel state measurement configuration by the downlink MAC CE.

5. The method of claim 1, wherein:
the set of input data items to the network-side AI model comprising at least one of:
channel state information reference signal (CSI-RS) or synchronization signal blocks (SSBs) measurement results;
time information associated with the CSI-RS or SSBs measurement results;
trajectory information of the wireless terminal device;
beam information;
location information of the wireless terminal device;
device orientation information of the wireless terminal device; or
speed information of the wireless terminal device; and
the set of input data items to the network-side AI model are transmitted from the wireless terminal device via one of:
a UCI on PUCCH;
a UCI on physical uplink shared channel (PUSCH); or
an uplink MAC CE.

6. The method of claim 1, wherein:
the NCA comprises one of:
switching an uplink or downlink beam;
switching a plurality of uplink or downlink beams sequentially; or
reconfiguring a current transmission configuration information (TCI) state pool if there is only one TCI state in the current TCI state pool; and
the NCA or the indication for the NCA is transmitted to the wireless terminal device via a downlink MAC CE or a downlink control information (DCI) message.

7. The method of claim 1, where the at least one AI network configuration management task is:
time-based according to an AI timer that can be enabled by the at least one wireless network node to set a period of time for the AI network configuration mode;
triggered by detection of one of network event comprising one of a beam failure, a radio link failure, a deactivation of a bandwidth part (BWP) or a serving cell associated with the AICS, a handover command, or a MAC reset; or
based on a performance evaluation of the network-side AI model comprising a comparison between reference-signal-received-power (RSRP) inferred from the network-side AI model and actual measurement result.

8.-9. (canceled)

10. The method of claim 1, wherein the AI feedback data item comprises at least one of:
an AI-inferred RSRP value of CSI-RS or SSBs;
an actual RSRP values of the CSI-RS or SSBs;
an AI-inferred best beam sequence for a predefined or pre-configured time period; or
an actual best beam sequence for the predefined or pre-configured time period

11. The method of claim 1, wherein determining the network-side AI model according to the request for AICS comprises:
obtaining a pretrained AI model; or
training the network-side AI model by:
transmitting an AI-model input data configuration to the wireless terminal device;
receiving training dataset from the wireless terminal device the training dataset being generated by the wireless terminal device according to the AI-model input data configuration; and
performing a training or reinforcement-training process to generate the network-side AI model based on the training dataset.

12.-14. (canceled)

15. The method of claim 1, wherein:
the at least one wireless network node comprises a wireless access network node and an AI-function entity;
the request for the AICS from the wireless terminal device is received at the wireless network node and relayed to the AI-function entity;
the method further comprises transmitting by the AI-function entity an acknowledgement message in response to receiving the request for the AICS from the wireless access network node, the acknowledgement message comprising at least one of:
information associated with the network-side AI model; or
AI-model-performance evaluation information.

16.-17. (canceled)

18. The method of claim 1, further comprising:
selecting a UE-side AI model according to the request for AICS; and
activating the UE-side AI model in the wireless terminal device or downloading the UE-side AI model to the wireless terminal device,
wherein the set of input data items to the network-side AI model comprises a set of output of the UE-side AI model generated by the wireless terminal device and transmitted to the at least one wireless network node.

19.-22. (canceled)

23. A method, by a wireless terminal device, comprising:
transmitting a request for AI configuration service (AICS) to at least one wireless network node;
receiving a management configuration for the AICS;
receiving an activation indication associated with a UE-side AI model;
receiving a set of assistant information items associated with the UE-side AI model;
in response to the activation indication, performing an AI-inference to generate an inference data item using the UE-side AI model based on the set of assistant information items;
transmitting the inference data item to the at least one wireless network node;
receiving a network configuration action (NCA) determined by the at least one wireless network node based on the inference data item; and
performing or assisting the at least one wireless network node in performing AI service management according to the management configuration for the AICS and the inference data item.

24. The method of claim 23, wherein the request for AICS is transmitted via one of:
an uplink Media Access Control (MAC) control element (CE) from the wireless terminal device;
an uplink control information (UCI) message from the wireless terminal device;
a physical uplink control channel (PUCCH) scheduling request (SR) from the wireless terminal device;
a UE assistance information in a radio resource control (RRC) message from the wireless terminal device; or
a capability signaling of the wireless terminal device.

25. The method of claim 24, wherein the request for AICS comprises at least one of:
an AI function indicator for indicating an AI configuration function among a plurality of AI configuration functions, the plurality of AI configuration functions comprising at least:
AI-based spatial beam management configuration;
AI-based temporal beam management configuration;
AI-based CSI feedback configuration; and
AI-based wireless terminal positioning configuration; or
AI-model information comprising at least one of:
an identifier of the UE-side AI model;
a processing time for inference of the UE-side AI model;
lifecycle information for the UE-side AI model;
an input data type for the UE-side AI model;
an output data type for the UE-side AI model; or
a suggested radio resource configuration (RRC) for input data items of the UE-side AI model.

26. The method of claim 23, wherein the management configuration for the AICS is received via a radio resource configuration (RRC) message, and comprises one of an RRC configuration or reconfiguration for CSI measurement and report of AI-based beam management.

27. The method of claim 23, wherein the activation indication associated with a UE-side AI model is received at the wireless terminal device via one of:
a downlink MAC CE comprising a first identifier associated with the UE-side AI model and a second identifier associated with the AI configuration function; or
an RRC message comprising an activation flag.

28. The method of claim 23, wherein:
the set of assistant information items comprises CSI-RS or SSB reference signal for an AI-based beam management; and
performing the AI-inference is based on measurement results of the CSI-RS or SSB reference signal.

29.-31. (canceled)

32. The method of claim 23, wherein performing or assisting the at least one wireless network node in performing the AI service management according to the management configuration for the AICS and the inference data item comprises deactivating the UE-side AI model when detecting a beam failure, a radio link failure, a deactivation of a bandwidth part (BWP) or a serving cell associated with the AICS, a handover command, or a MAC reset.

33.-38. (canceled)

39. At least one wireless network node or the wireless terminal device, comprising a memory for storing instructions and a processor for executing the instructions to implement:
activating an Artificial Intelligence (AI) network configuration mode in response to receiving a request for AICS (AI configuration service) from a wireless terminal device;
determining a network-side AI model according to the request for AICS;
receiving a set of input data items to the network-side AI model from the wireless terminal device;
determining a network configuration action (NCA) based on an inference from the network-side AI model based on the set of input data items;
transmitting the NCA or an indication for the NCA to the wireless terminal device;
receiving an AI feedback data item from the wireless terminal device, the AI feedback data item being generated by the wireless terminal device based on a deployment outcome of the NCA according to the indication; and
preforming at least one AI network configuration management task according to the AI feedback data item.

40. A wireless communication apparatus, comprising a memory storing one or more programs and a processor electrically coupled to the memory and configured to execute the one or more programs to perform the method of claim 23.
